(19) United States
(12) Patent Application Publication
(10) Pub. No.: US 2019/0036863 A1
(43) Pub. Date: Jan. 31, 2019

(54) MANAGING GOVERNMENT MESSAGES

(71) Applicant: Ryan Bonham, Provo, UT (US)

(72) Inventor: Ryan Bonham, Provo, UT (US)

(21) Appl. No.: 16/141,895

(22) Filed: Sep. 25, 2018

Related U.S. Application Data
(63) Continuation-in-part of application No. 14/717,146, filed on May 20, 2015, now abandoned.

(51) Int. Cl. H04L 12/58; G06F 17/27; G06N 3/08

(52) U.S. Cl. CPC H04L 51/26; H04L 51/12; G06N 3/08; H04L 51/22; G06F 17/2705; H04L 51/18

(57) ABSTRACT

For managing government messages, code receives a message and stores the message. In addition, the code communicates the message to accounts through at least one of a plurality of communication channels based on message categories and structured message restrictions. The structured message restrictions include full access, partial access, and no access restrictions. A structured message restriction is associated with each message category for each account.

### CROSS-REFERENCE TO RELATED APPLICATIONS

This is a continuation-in-part application of and claims priority to U.S. patent application Ser. No. 14/717,146 entitled “MANAGING GOVERNMENT MESSAGES” and filed on May 20, 2015 for Ryan Bonham, which is incorporated herein by reference.

### BACKGROUND

### Field

The subject matter disclosed herein relates to messages and more particularly relates to managing government messages.

### Description of the Related Art

Governments, particularly local governments, have a number of stakeholders including residents, employees, and officials that must communicate to provide effective services.

### BRIEF SUMMARY

A method for managing government messages is disclosed. Code receives a message and stores the message. In addition, the code communicates the message to accounts through at least one of a plurality of communication channels based on message categories and structured message restrictions. The structured message restrictions include full access, partial access, and no access restrictions. A structured message restriction is associated with each message category for each account. A program product and apparatus also perform the functions of the apparatus.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a government message system;

FIG. 2A is a table illustrating one embodiment of structured message restrictions by account class for message categories;

FIG. 2B is a table illustrating one alternate embodiment of structured message restrictions by account class for message categories;

FIG. 3A is a schematic block diagram illustrating one embodiment of a management database;

FIG. 3B is a schematic block diagram illustrating one embodiment of a message; and

FIG. 3C is a schematic block diagram illustrating one embodiment of a note;

FIG. 3D is a schematic block diagram illustrating one embodiment of a self-modifying message data structure;

FIG. 4A is a schematic block diagram illustrating one embodiment of a computer;

FIG. 4B is a schematic block diagram illustrating one embodiment of computing resources;

FIG. 4C is a schematic diagram illustrating one embodiment of neural network;

FIG. 4D is a schematic block diagram illustrating one embodiment of long short term memory network; and

FIG. 5 is a schematic flow chart diagram illustrating one embodiment of a method for managing government entity messages.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage medium storing machine readable code, computer readable code, and/or program code, referred hereafter as code. The computer readable storage medium may be tangible, non-transitory, and/or non-transmission. The computer readable storage medium may not embody signals. In a certain embodiment, the storage devices only employ signals for accessing code.

The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. These code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

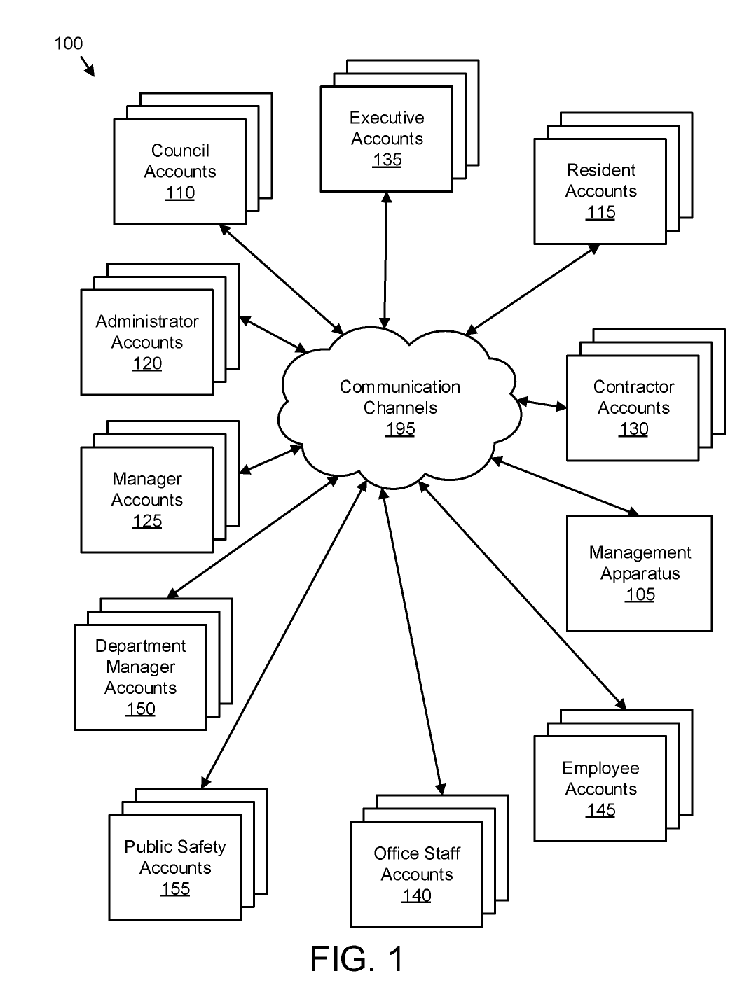

FIG. 1 is a schematic block diagram illustrating one embodiment of government message system 100 for a government entity. The government message system 100 may provide communications to government personnel within a government entity, as well as to residents within the government entity's jurisdiction, contractors for the government entity, and the like. The government entity may be a city government, a county government, an unincorporated municipality government, or the like.

The system 100 includes a management apparatus 105, council accounts 110, resident accounts 115, administrator accounts 120, manager accounts 125, contractor accounts 130, office staff accounts 140, employee accounts 145, department manager accounts 150, public safety accounts 155, and executive accounts 135. The council accounts 110, resident accounts 115, administrator accounts 120, manager accounts 125, contractor accounts 130, office staff accounts 140, employee accounts 145, department manager accounts 150, public safety accounts 155, and executive accounts 135 are examples of account classes. The account classes may identify the role of the user of each account within the government entity.

The management apparatus 105, council accounts 110, resident accounts 115, administrator accounts 120, manager accounts 125, contractor accounts 130, office staff accounts 140, employee accounts 145, department manager accounts 150, public safety accounts 155, and executive accounts 135 may communicate through communication channels 195. The communication channels 195 may comprise one or more of the Internet, a cellular telephone network, an instant messaging system, a wide area network, a local area network, or the like. The communication channels 195 may transmit messages. The messages may be organized as digital data packets, analog signals, or the like

A first message may be sent through one or more communication channels 195. For example, the management apparatus 105 may communicate the first message through a cellular telephone network to a council account 110 and communicate the first message through the Internet to a manager account 125.

The messages may comprise email messages, Short Message Service (SMS), messages, telephonic messages, text messages, mobile phone application data, and custom data structures. The messages may comprise notes with task descriptions for tasks to be performed by the users of one or more accounts. Alternatively, the messages may comprise requests, notices, notifications, announcements, bills, work orders, invoices, and the like.

An administrator may have access to the management apparatus 105 through an administrator account 120. The council accounts 110, resident accounts 115, administrator accounts 120, manager accounts 125, contractor accounts 130, office staff accounts 140, employee accounts 145, department manager accounts 150, public safety accounts 155, and executive accounts 135 may be created by the administrator through the administrator account 120. In one embodiment, accounts are created when a relationship is formed between an individual and the government entity. Each account may include a preexisting email address, telephone number, Universal Resource Locators (URL), SMS account, and the like through which an account user may be contacted. Alternatively, each account may access a messaging system hosted by the management apparatus 105.

In one embodiment, the council accounts 110, resident accounts 115, administrator accounts 120, manager accounts 125, contractor accounts 130, office staff accounts 140, employee accounts 145, department manager accounts 150, public safety accounts 155, and executive accounts 135 may direct messages to the email addresses telephone numbers, URLs, SMS accounts, and the like associated with destination accounts. Alternatively, the council accounts 110, resident accounts 115, administrator accounts 120, manager accounts 125, contractor accounts 130, office staff accounts 140, employee accounts 145, department manager accounts 150, public safety accounts 155, and executive accounts 135 may be accessed by logging in to the management apparatus 105.

In addition, each user of the council accounts 110, resident accounts 115, administrator accounts 120, manager accounts 125, contractor accounts 130, office staff accounts 140, employee accounts 145, department manager accounts 150, public safety accounts 155, and executive accounts 135 may designate preferences for sending and receiving messages. For example, a first council account 110 may specify that messages are to be first sent through email and then sent through a cellular telephone network if email was unsuccessful.

The government entity may include many stakeholders, each with one or more roles and communication requirements. For example, a user may be a resident residing within the jurisdiction of the government entity. The user may communicate with personnel within the government entity regarding government services. In addition, the same user may also be on a governing council for the government entity and the involved in matters of official business.

An administrator may oversee the functions of the government message system 100. Office staff may be responsible for performing clerical functions for the government entity. Contractors and employees may provide services to residents and internally to the government entity. Employees and public safety personnel may also be responsible for enforcing regulations and laws within the jurisdiction.

An executive may be an elected official such as a mayor or an appointed official such as a city manager or police chief. The executive may be authorized to approve specified requests. Department managers and managers may manage functions of the government entity. The department managers and managers may also be authorized to approve specified requests.

The people in these roles may communicate the messages to manage the providing of services and enforcement of laws within the jurisdiction. The messages may reference a note. The note may include information on a task, requests, notices, notifications, announcements, infractions, work orders, invoices, and the like. In addition, the note may reference one or more attached documents. In one embodiment, a plurality of related messages may reference one or more notes.

For example, a resident may send a message referencing a first note from a resident account 115 to one or more council accounts 110. A member of the governing council may respond with another message that also references the first note. In addition, a note may be added to with each communication.

Some messages and/or notes may include confidential and/or public safety information. Many of the stakeholders within the government entity should not be privy to specified messages because of the messages contain confidential information. However, it may be vital that other stakeholders receive the messages. The embodiments described herein manage access to messages communicated between the various accounts based on the role of each account within the government entity.

In the past, government entities have relied on email and other messaging systems to communicate internally and with residents. Unfortunately, such systems do not prevent the inadvertent communication of confidential or public safety information to stakeholders that should not receive such information. As a result, confidential and/or public safety information is occasionally compromised, creating a liability risk for the government entity and embarrassment or loss to residents.

By efficiently managing access to messages, the embodiments assure that necessary information is available where needed, reduce the perforation of irrelevant information, and protect confidential and public safety information. As a result, the management of the government entity is more efficient and responsive to the needs of the residents.

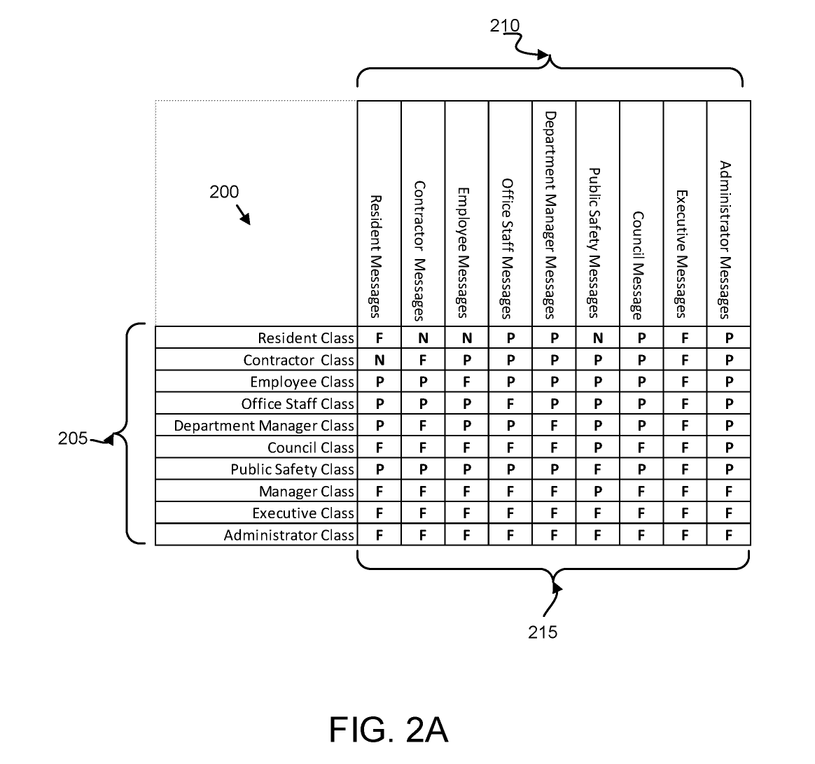

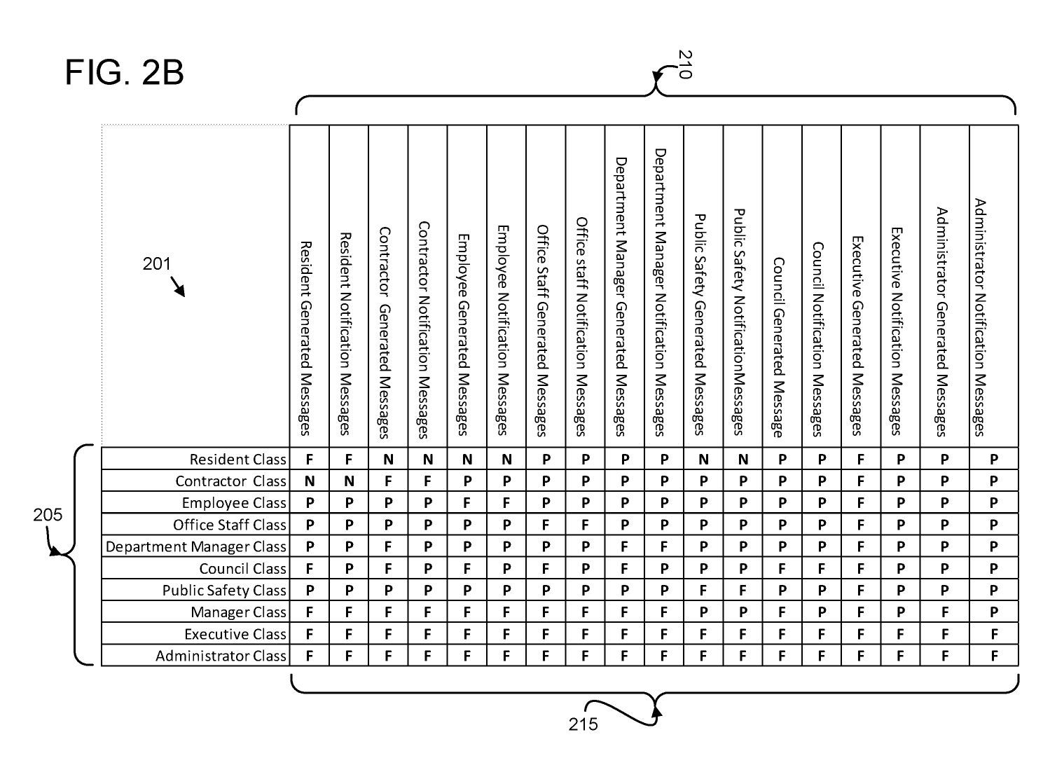

FIG. 2A is a table 200 illustrating one embodiment of structured message restrictions by account class 205 for message categories 210. The account classes 205 are the classes of the accounts of FIG. 1. The message categories 210 categorize messages sent between the accounts of FIG. 1. In one embodiment, each message category 210 is assigned a message category value.

The account classes 205 include a resident class comprising the resident accounts 115, a contractor class comprising the contractor accounts 130, an employee class comprising the employee accounts 145, and office staff class comprising the office staff accounts 140, the department manager class comprising the department manager accounts 150, a council class comprising the council accounts 110, a public safety class comprising the public safety accounts 155, a manager class comprising the manager accounts 125, and executive class comprising the executive accounts 135, and the administrator class comprising the administrator accounts 120. Because a governing council member may also be a resident, in one embodiment, a governing council member may have a council account 110 and a separate resident account 115. Alternatively, the governing council member may have a single council account 110 that is part of both the council class and the resident class.

The message categories 210 include resident messages, contractor messages, employee messages, office staff messages, department manager messages, public safety messages, council messages, executive messages, and administrator messages. One of skill in the art will recognize that the embodiments may be practiced with additional account classes 205 and message categories 210.

In one embodiment, a resident message is created by a resident account 115. For example, a first resident account 115 may create a first resident message regarding a leaking water main. Alternatively, the resident message may be a message that is last added to by the resident account 115. For example, a first council account 110 may create a first council message seeking resident input on a park renovation. The first resident account 115 may respond to the first council message, creating a resident message.

A contractor message may be created by a contractor account 130. Alternatively, the contractor message may be a message that is last added to by a contractor account 130. An employee message may also be a message that is created by an employee account 145 and/or manager account 125 or a message that is last added to by the employee account 145 and/or the manager account 125.

An office staff message may be created by an office staff account 140 or may be a message that is last added to may an office staff account 140. An administrator message may be a message that is created by or last added to by administrator account 120.

A public safety message may be a message that is created by or last added to by a public safety account 155. In addition, the public safety message may be created by or last added to by accounts other than a public safety account 155, but may be a public safety message based on a public safety rating.

A department manager message may be a message that is created by or last added to by department manager account 150. Alternatively, the department manager message may be created by another account but may be identified by the system 100 as a department manager message based in response to the message satisfying specified criteria. For example, messages with a specified message priority or specified keywords in a description may be classified as department manager messages. In an alternate embodiment, the department manager message may be created by another account but may be identified by the system 100 as a department manager message based on the proxy account

A council message may be created by or last added to by a council account 110. Alternatively, the council message may be created by another account but may be identified by the system 100 as a council message based on the proxy account.

An executive message may be created by or last added to by an executive account 135. Alternatively, the executive message may be created by another account but may be identified by the system 100 as an executive message based on a proxy account.

The communication of messages between accounts of the account class 205 is regulated by structured message restrictions 215. The structured message restrictions 215 comprise a full access restriction, a partial access restriction, and a no access restriction. The table 200 shows the structured message restrictions 215 of each message category 210 for each account class 205, where “F” indicates a full access restriction, “P” indicates a partial access restriction, and “N” indicates a no access restriction.

In one embodiment, the full access restriction permits access to all messages of a specified message category 210 to the destination accounts of the specified account class 205. For example, the resident class has a full access restriction for executive messages.

The partial access restriction may permit access by a first account to a first message only if the first account is explicitly listed as a recipient of the first message. For example, a first resident account 115 may receive a first council message if the first resident account 115 is explicitly listed as a recipient of the first board member message.

In one embodiment, the partial access restriction may permit access by the first account to the first message if a message priority for the first message exceeds a message priority threshold 650. The message priority may be calculated for the account class 205. Alternatively, the message priority may be calculated for each account of one or more account classes 205.

In an alternate embodiment, the partial access restriction permits access to the first message by the first account if a visible flag for the first message is set for the first account. For example, the first resident account 115 may receive the first council message if the visible flag for the first council message is set for the first resident account 115.

In one example, an identifier of each resident account 115 related to a first message is included with the first message. For example, the first council message may be regarding the construction of an outbuilding by the first resident account 115. However, the first resident account 115 may only be given access to the first message if a visible to resident flag is set for the first message. Setting the visible flag may allow the first resident account 115 to access the first message. Otherwise, the first resident account 115 may not access the first message although the identifier of the first resident account 115 is included with the message. This provides extra protection to assure that confidential information is not accidentally sent to a resident.

The no access restriction may prevent all access by an account class 205 to the specified message category 210. For example, accounts of the resident class may be restricted from all access to messages of the public safety message class.

FIG. 2B shows a table 201 illustrating one alternate embodiment of structured message restrictions by account class 205 for the message categories 210. In the depicted embodiment, each message of the message categories 210 includes both “generated” and “notification” messages. A “generated” message is generated by the corresponding account class 205 while “notification” message is directed to the corresponding account class 205.

For example, a resident generated message is sent by a resident of the resident class. Similarly, a resident notification message is sent to one or more residents of the resident class.

A “generated” message of a message type may have a different structured message restriction 215 than the structured message restriction 215 for the “notification” message of the message type. For example, the contractor notification message has a partial access restriction for the council class, but the corresponding contractor generated message has a full access restriction for the council class.

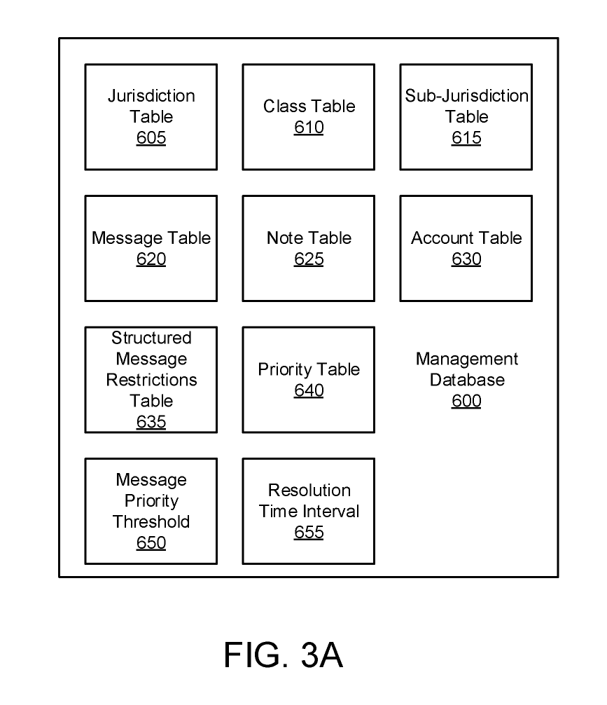

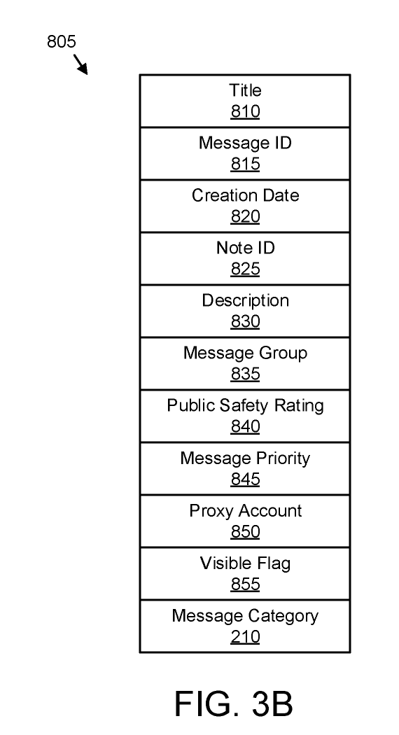

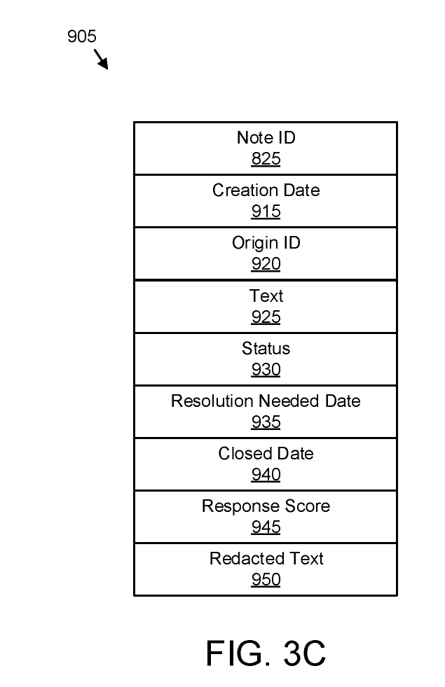

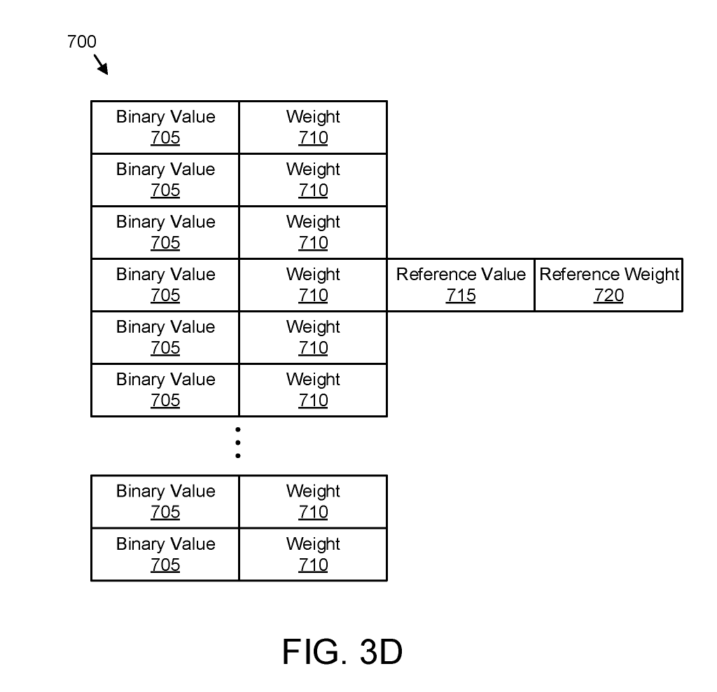

FIG. 3A is a schematic block diagram illustrating one embodiment of a management database 600. The management database 600 may be organized as a data structure in a memory. In the depicted embodiment, the management database 600 includes a jurisdiction table 605, a class table 610, a sub jurisdiction table 615, a message table 620, a note table 625, an account table 630, a structured message restriction table 635, a priority table 640, a message priority threshold 650, and a resolution time interval 655.

The management database 600 may support the management of a plurality of government entities. The stakeholders of each government entity may access the management database 600 and the management apparatus 105 to conduct business with their respective government entity.

In one embodiment, the jurisdiction table 605 comprises entries for the plurality of government entities. Each entry in the jurisdiction table 605 may include a jurisdiction identifier for a government entity. In a certain embodiment, each entry in jurisdiction table 605 may also identify one or more administrator accounts 120 for the government entity. In one embodiment, only the administrator account 120 for a first government entity may make administrative changes to the management database 600 for the first government entity.

The class table 610 may list the account classes 205 for each account of the account table 630. In one embodiment, the class table 610 associates an identifier of each account with an account class 205.

The sub jurisdiction table 615 may list one or more sub jurisdictions for each government entity. For example, the sub-jurisdiction table 615 may store one or more wards that are associated with a city government entity. In one embodiment, each entry of the sub jurisdiction table 615 includes a sub-jurisdiction identifier that may be associated with an account. A manager account 125 for the manager of a city department that provides services to a specified city ward may store the sub-jurisdiction identifier for the specified city ward.

The message table 620 may store each message communicated to and from the management apparatus 105. The organization of each message in the message table 620 will be described in detail hereafter.

The note table 625 may store notes that are attached to each message. In one embodiment, a note comprises a task, a request, a notice, a notification, a summons, an announcement, a bill, a work order, an invoice, and the like. Each note may be attached to a plurality of messages.

The account table 630 may store each account. In one embodiment, each account table entry includes an account identifier, one or more communication addresses for the account, an account class 205, a jurisdiction identifier, and a sub jurisdiction identifier.

The structured message restriction table 635 may be organized as a table associating each account class 205 and message category 210 with a structured message restriction 215. In one embodiment, the structured message restrictions 215 associate a restriction with each account class/message category pair. In a certain embodiment, the structured message restriction table 635 is organized as a table similar to the tables 200 and 201 of FIGS. 2A-B. Alternatively, the structured message restriction table 635 is organized as logical rules.

The priority table 640 may be used to generate a message priority for each message. In one embodiment, the priority table 640 is indexed by keywords. Each keyword is associated with a message priority. For example, the keyword “flood” may be associated to a numerical message priority of 9. Alternatively, the keyword “flood” may be associated to the message priority of “high.” In addition, each keyword may be associated with a public safety rating. The public safety rating may be a numerical rating and/or a descriptive rating.

FIG. 3B is a schematic block diagram illustrating one embodiment of a message 805. The message 805 maybe organized as an entry in the message table 620. In the depicted embodiment, each message 805 includes a title 810, a message identifier 815, a creation date 820, a note identifier 825, a description 830, a message group 835, a public safety rating 840, a message priority 845, a proxy account 850, the visible flag 855, and a message category 210.

Each message 805 may have a separate entry in the message table 620. The title 810 may label the message 805. The message identifier 815 may identify the message 805 within the message table 620. The creation date 820 may be a time stamp of when the message 805 is created.

The note identifier 825 associates a note from the note table 625 with the message 805. The node identifier 825 may be an index to the note table 625. The description 830 may describe the message 805. In one embodiment, an account must have the full access restriction in order to access the description 830.

The message group 835 may describe a group for the message 805. In one embodiment, the message group 835 is associated with the department or unit of the government entity. Alternatively, the message group 835 may be associated with the sub-jurisdiction of the government entity.

The public safety rating 840 may describe the level of public safety concern relative to the message 805. The public safety rating 840 may be a numerical rating. Alternatively, the public safety rating 840 may be a descriptive rating such as “high,” “medium,” and “low.”

The message priority 845 may describe the priority of the message 805. The message priority 845 may be a numerical priority. In addition, the message priority 845 may include a date priority. In a certain embodiment, the message priority 845 may be a descriptive rating such as “high,” “medium,” and “low.”

The proxy account 850 may specify a first account for which a second account may send the message 805 on behalf of. For example, a department manager account 150 may send the message 805 on behalf of the executive account 135 of the mayor.

The visible flag 855 may indicate a destination account and whether the visible flag 855 is set. If the visible flag 855 is set, the destination account may access the message 805 even if the destination account has a partial access restriction. However, if the account has a no access restriction, the account may not access the message even if the visible flag 855 is set. The message category 210 may indicate the message category of the message 805.

FIG. 3C is a schematic block diagram illustrating one embodiment of a note 905. The note 905 may be an entry in the note table 625. Each note 905 includes a note identifier 825, a creation date 915, an origin identifier 920, text 925, a status 930, a resolution needed date 935, a closed date 940, a response score 945, and redacted text 950. The note identifier 825 may identify the note 905 within the note table 625. The creation date 915 may be a time stamp of when the note 905 is created. The origin identifier 920 may identify the government entity department, service, regulation, resident, or dwelling associated with the note 905. In one embodiment, the origin identifier 920 is an account. Through the origin identifier 920, the note 905 can also be associated with additional accounts.

The text 925 may include a description of a task, a request, a notice, a notification, an announcement, a bill, a work order, an invoice, and the like. In one embodiment, the text 925 further includes one or more attached documents. The redacted text 950 may be a redacted version of the text 925.

The status 930 may comprise one of the group consisting of a closed status, a response status, an action required status, and an office status. The closed status may indicate that the matter of the note is complete and that no further action is required. The response status may indicate whether an executive, governing council, or governing entity department has responded to the notes 905. An action status may indicate that note 905 requires some action to be complete. The office status may indicate that one or more administrative functions are required.

The resolution needed date 935 may specify when the issues described by the note 905 are required to be resolved. The resolution date 935 may be a date, time, or combinations thereof. The closed date 940 may be a time stamp when the status of the note 905 is changed to the closed status.

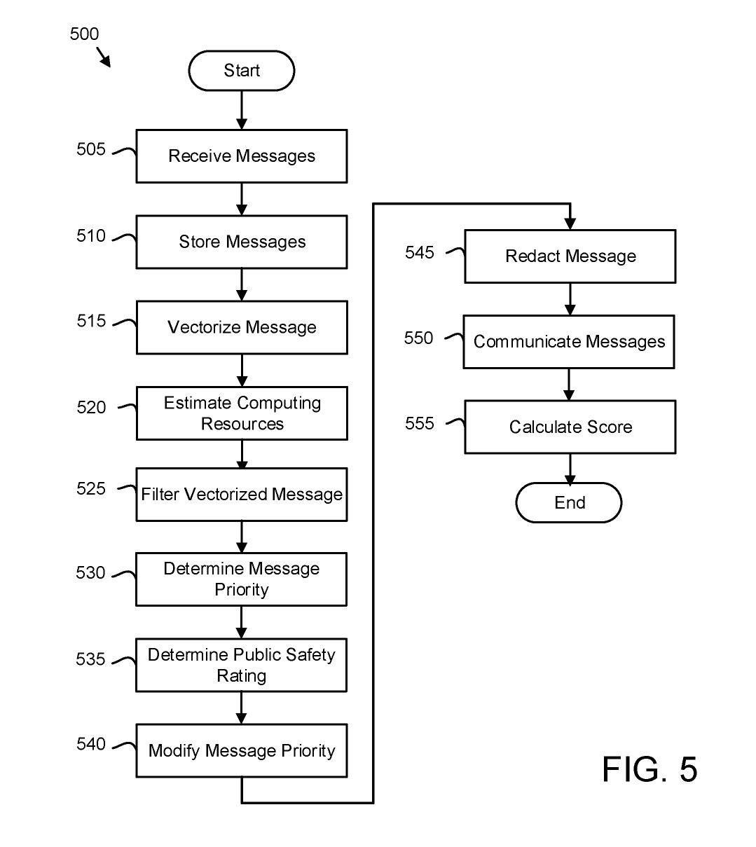

The response score 945 may be calculated as a function of a resolution time interval 655, the message priority 845, and the public safety rating 840. The calculation of the response score 945 is described in more detail in FIG. 5.

FIG. 3D is a schematic block diagram illustrating one embodiment of a self-modifying message data structure 700. The self-modifying message data structure 700 may be organized in a memory. In the depicted embodiment, the self-modifying message data structure 700 includes a binary value 705 and a weight 710 for each word of sentence in the text 925 of the note 905 for the message 805. A plurality of self-modifying message data structures 700 may represent the entire text 925.

In one embodiment, if a word corresponding to a binary value 705 is in the sentence, the binary value 705 is asserted. For example, if the sentence included the word “emergency,” the binary value 705 corresponding to “emergency” would be asserted to a value such as one. In addition, each binary value 705 may be assigned a corresponding weight 710 as a function of the speech type of the corresponding word in the sentence. For example, subjects, verbs, and objects may be assigned higher weights 710. The weight 710 may be further modified as a function of word order. For example, the weight 710 of words that appear earlier in a sentence may be modified to a higher value.

In one embodiment, if a word in a first sentence is also included in a second sentence, the data structure 700 may be self-modified with a reference value 715 and a reference weight 720. The reference value 715 may refer to the instance of the word in the second sentence. The reference weight 720 may be calculated as a function of the weight 710 of the instance of the word in the second sentence. As a result, the data structure 700 is recursively self-modified as the weights 710 are calculated for each word of each sentence.

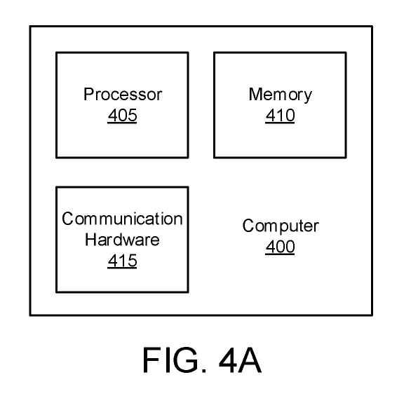

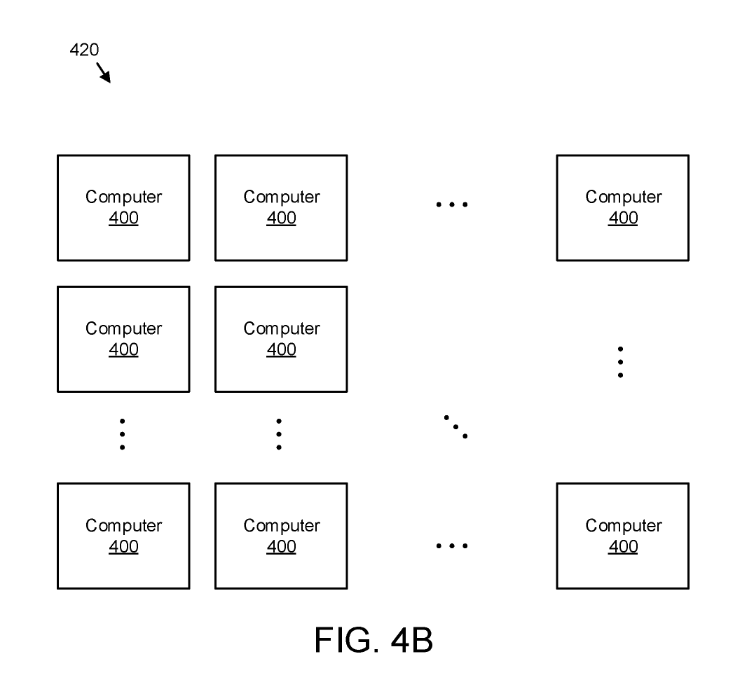

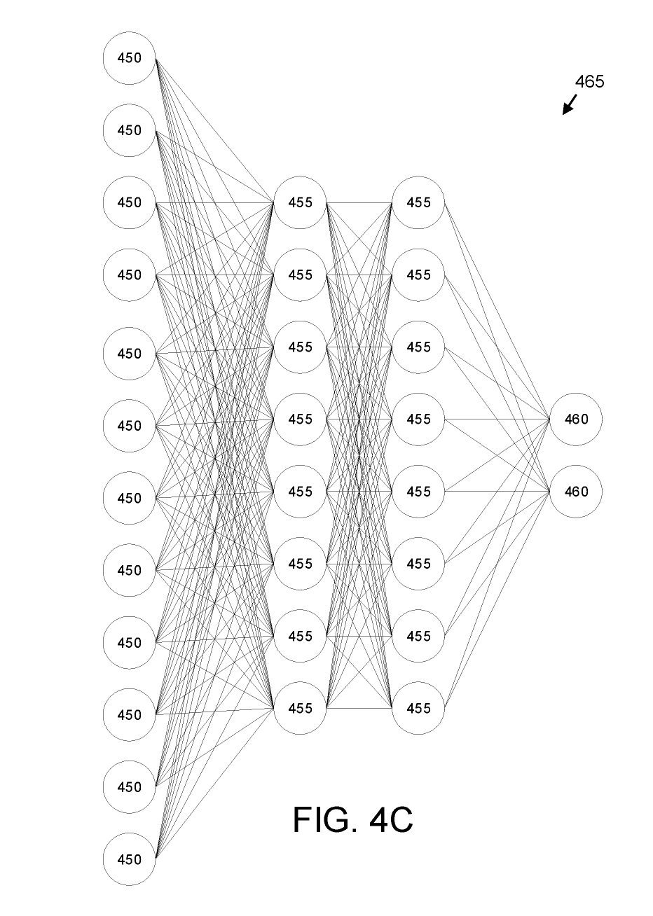

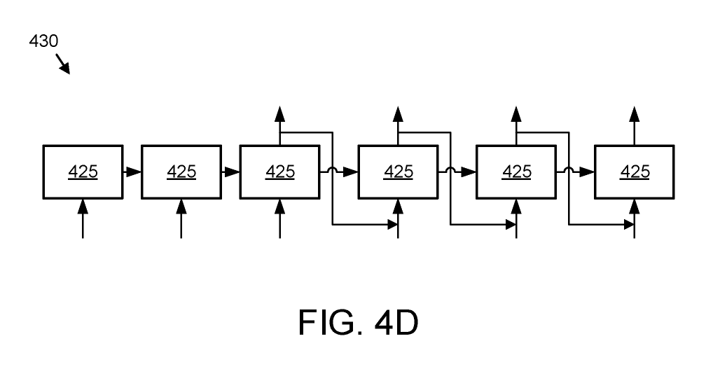

FIG. 4A is a schematic block diagram illustrating one embodiment of a computer 400. The computer 400 may comprise the management apparatus 105 of FIG. 1. The computer 400 includes a processor 405, a memory 410, and communication hardware 415. The memory 410 may store code. The memory 410 may be a semiconductor storage device, a hard disk drive, an optical storage device, a micromechanical storage device, or combinations thereof. The processor 405 may execute the code stored on the memory 410. The communication hardware 415 may communicate data and commands with external devices.

FIG. 4B is a schematic block diagram illustrating one embodiment of computing resources 420. In the depicted embodiment, the computing resources 420 include a plurality of computers 400. In one embodiment, each computer 400 is a portion of a semiconductor device. Alternatively, each computer 400 may be one of a plurality of blades of a server. One or more computers 400 may be assigned to filter the message 805 as computing resources 420.

FIG. 4C is a schematic diagram illustrating one embodiment of neural network 465. In the depicted embodiment, the neural network 465 includes input neurons 450, hidden neurons 455, and output neurons 460. The neural network 465 may be organized as a convolutional neural network, a recurrent neural network, and the like.

The neural network 465 may be trained with training data. The training data may include exemplary self-modifying message data structures 700. The neural network 475 may be trained using one or more learning functions while applying the training data to the input neurons 450 and known result values such as message priorities 845 or public safety ratings 840 for the output neurons 460. Subsequently, the neural network 465 may receive actual data at the input neurons 450 and make predictions at the output neurons 460 based on the actual data. The actual data may include data from the self-modifying message data structure 700.

In one embodiment, a first neural network 465 is trained using the exemplary self-modifying message data structures 700 and exemplary message priorities 845. A second neural network 465 may be trained using the exemplary self-modifying message data structures 700 and exemplary and exemplary public safety ratings 840. As a result, each neural network 465 exhibits expertise in a separate linguistic determination. The first neural network 465 is trained to determine the message priority 845 while the second neural network 465 is trained to determine the public safety rating 840.

FIG. 4D is a schematic block diagram illustrating one embodiment of long short term memory (LSTM) network 430. In the depicted embodiment, the LSTM network 430 comprises a plurality of neural network copies 425. Each neural network copy 425 may be trained as described in FIG. 4C. In addition, each neural network copy 425 passes a message to a successor neural network copy 425. As a result, the LSTM network 430 maintains both long and short-term memory of previous results.

FIG. 5 is a schematic flow chart diagram illustrating one embodiment of a method 500 for managing government entity messages 805. The method 500 may manage the messages 805 and associated notes 905 communicated with the government message system 100. The functions of the method 500 may be performed by the code stored in the memory 410 and executed by the processor 405.

The method 500 begins, and in one embodiment, the processor 405 receives 505 the message 805. The message 805 may be communicated from an account through the communication channels 195. In one embodiment, the processor 405 determines a first account sending the message 805 from a source address of the message 805.

The processor 405 may store 510 the message 805. The message 805 may be stored 510 in the message table 620. In one embodiment, the processor 405 parses the note 905 from the message 805 and stores the note 905 in the note table 625.

The processor 405 may vectorize 515 the message 805 into the self-modifying message data structure 700. In one embodiment, the processor 405 parses each sentence from the text 925 of the note 905 and vectorizes 515 each sentence into the self-modifying message data structure 700. In addition, the processor 405 may self-modify the data structure in response to instances of one or more given words appearing in one or more sentences.

The processor 405 may estimate 520 the computing resources 420 required to filter the self-modifying message data structure 700. The computing resources 420 may be estimated 520 based on the length of the text 925 and a number of recurring instances of each word in the text 925.

The processor 405 may filter 525 the vectorized message 805 by filtering the self-modifying message data structure 700. In one embodiment, the self-modifying message data structure 700 is filtered 525 by identifying a part of speech for each word and assigning a corresponding weight 710 to the word. The processor 405 may further filter 525 the self-modifying message data structure 700 by assigning the weight 710 based on the parts of speech of each word. The processor 405 may further filter 525 low importance words from each sentence. In one embodiment, low importance words are identified from a list. In addition, the processor 405 may identify reference values 715 of other instances of each word and recursively calculate the reference weight 720 for each word.

The processor 405 may determine 530 the message priority 845 for the message 805. The processor 405 may determine 530 the message priority 845 by presenting the self-modifying message data structure 700 to the neural network 465 and/or LSTM network 430. The neural network 465 and/or LSTM network 430 may determine the message priority 845 for the message 805.

The processor 405 may further determine 535 the public safety rating 840. The processor 405 may determine 535 the public safety rating 840 by presenting the self-modifying message data structure 700 to the neural network 465 and/or LSTM network 430. The neural network 465 and/or LSTM network 430 may determine the public safety rating 840 for the message 805.

In one embodiment, the processor 405 parses one or more keywords from the text 925 of the note 905 associated with the message 805. The processor 405 may further retrieve a message priority 845 and the public safety rating 840 from the priority table 640 using the one or more keywords. The message priority 845 and the public safety rating 840 may be stored with the message 805.

In one embodiment, the message priority 845 is modified 540 as a function of the message category 210 and the public safety rating 840. The processor 405 may parse the description 830 for the one or more keywords and retrieve the public safety rating 840 and the message priority MP 845 from the priority table 640. In addition, the processor 405 may calculate a modified message priority MMP using Equation 1, where PR is the public safety rating 840, MCV is the message category value associated with the message category 210.

MMP=(MCV*√(MP*PR))/K Equation 1

In one embodiment, a recipient account of the message 805 may modify 540 the message priority 845 and the public safety rating 840. The structured message restrictions table 635 may specify which accounts may modify the message priority 845 and or the public safety rating 840. In one embodiment, only a public safety account 155 may modify the public safety rating 840. In a certain embodiment, only one of an executive account 135, a council account 110, a public safety account 155, and/or department manager account 150 may modify the message priority 845. Alternatively, a manager account 125, employee accounts 145, and office staff account 140 may modify the message priority 845.

In one embodiment, the processor 405 redacts 545 the text 925 of the message 805 to a limited set of information for accounts with the partial access restriction. The text 925 may be redacted 545 by removing personal identifiers such as a name, an address, a phone number, an email, or the like. In addition, the text 925 may be redacted 545 by removing one or more sensitive words such as “homicide.” The redacted text 950 may be stored with the note 905. In one embodiment, the redacted text 950 limits the selectable options available to the recipient.

The processor 405 may communicate 550 the message 805 to one or more accounts subject through at least one of a plurality of communication channels 195 based on the message categories 210 and structured message restrictions 215. A structured message restriction 215 is associated with each message category 210 for each account. In one embodiment, the processor 405 receives a list of the destination accounts with the message 805. Alternatively, the processor 405 may create a list of the destination accounts from a destination label. For example, a resident label may specify that the message 805 be sent to all resident accounts 115. The processor 405 may further retrieve addresses for each of the resident accounts 115, and communicate 520 the message 805 to each of the addresses.

In one embodiment, the processor 405 communicates 550 the message 805 communicates the message 805 to a first account in the list of destination accounts with a partial access restriction only if the message priority 845 for the message 805 exceeds the message priority threshold 650. In a certain embodiment, destination accounts with a partial access restriction receive only the redacted text 950. In addition, the processor 405 may communicate 550 the message 805 to all accounts on the list of destination accounts with the full access restriction. The processor 405 may not communicate 550 the message 805 to the accounts on the list of destination accounts with the no access restriction.

In one embodiment, the processor 405 communicates 550 the message 805 by permitting accounts that are originators and/or recipients of the message 805 to access the message 805 at a later date. For example, a council account 110 may search for all messages related to a specified resident account 115. If the council account 110 was an originator or recipient of the message 805, the council account 110 may access the message 805.

In one embodiment, the associated note 905 identified by the note identifier 825 is communicated and/or accessed with the message 805. The note 905 may be integrated with the message 805.

In one embodiment, the processor 405 calculates 555 a response score 945 for the note 905 associated with the message 805 and the method 600 ends. The processor 405 may calculate 525 the response score 945 when the status 930 of the note 905 is a closed status. The processor 405 may record the closed date 940 when the status 930 is the closed status. The resolution needed date 935 may be established when a task or other action is created. The processor 405 may calculate 525 a resolution time interval 655 as the time from the resolution needed date 935 to the closed date 940. T

The response score RS 945 may be calculated as a function of the resolution time interval 655, the message priority 845, and the public safety rating 840. In one embodiment, the response score RS 945 may be calculated using Equation 2, where MP is the message priority 845, RT is one if the closed date 940 is before the resolution needed date 935 and otherwise is a number of days from the resolution needed date 935 to the closed date 940, and L is a nonzero constant.

RS=L*MP/√RT Equation 2

The embodiments communicate the message 805 to accounts through the communication channels 195 based on the message category 210 in accordance with the structured message restrictions 215. As a result, the dissemination of confidential information and/or public safety information is controlled within the government entity.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
receiving, by use of a processor, a message;
storing the message;
vectorizing the message into a self-modifying message data structure comprising a binary value and a weight for each word of text of a note for the message, wherein the weight is modified as a function of word order;
determining the message priority from the vectorized message using a first neural network trained with message priorities;
determining the public safety rating from the vectorized message using a second neural network trained with public safety ratings;
modifying the message priority as a function of the public safety rating;
communicating the message to accounts through at least one of a plurality of communication channels based on message categories and structured message restrictions comprising full access, partial access, and no access restrictions, wherein a structured message restriction is associated with each message category for each account, the partial access restriction permits access to a first message by a first account only if a message priority for the first message exceeds a message priority threshold, and the message categories comprise resident messages, contractor messages, employee messages, office staff messages, department manager messages, public safety messages, council messages, executive messages, and administrator messages, wherein the note is redacted to a limited set of information for accounts with a partial access restriction.

2. The method of claim 1, the method further comprising:
estimating computing resources required to filter the self-modifying message data structure; and
filtering the self-modifying message data structure using the estimated computing resources, wherein filtering modifies the self-modifying message data structure.

3. The method of claim 1, wherein the limited set of information limit selectable options available to the recipient.

4. The method of claim 1, wherein the partial access restriction further permits access to the first message by the first account if a visible flag is set for the first account.

5. The method of claim 1, the method further comprising calculating a response score as a function of a resolution time interval, a message priority, and a public safety rating.

6. The method of claim 1, wherein each message comprises a title, a message identifier, a creation date, and a note identifier for the note.

7. The method of claim 6, wherein each note comprises a status, a closed date, and a resolution needed date.

8. A program product comprising a non-transitory computer readable storage medium that stores code executable by a processor to perform:
receiving a message;
storing the message;
vectorizing the message into a self-modifying message data structure comprising a binary value and a weight for each word of text of a note for the message, wherein the weight is modified as a function of word order;
determining the message priority from the vectorized message using a first neural network trained with message priorities;
determining the public safety rating from the vectorized message using a second neural network trained with public safety ratings;
modifying the message priority as a function of the public safety rating; and
communicating the message to accounts through at least one of a plurality of communication channels based on message categories and structured message restrictions comprising full access, partial access, and no access restrictions, wherein a structured message restriction is associated with each message category for each account, the partial access restriction permits access to a first message by a first account only if a message priority for the first message exceeds a message priority threshold, and the message categories comprise resident messages, contractor messages, employee messages, office staff messages, department manager messages, public safety messages, council messages, executive messages, and administrator messages, wherein the note is redacted to a limited set of information for accounts with a partial access restriction.

9. The program product of claim 8, the processor further:
estimating computing resources required to filter the self-modifying message data structure; and
filtering the self-modifying message data structure using the estimated computing resources, wherein filtering modifies the self-modifying message data structure.

10. The program product of claim 8, wherein the limited set of information limit selectable options available to the recipient.

11. The program product of claim 8, wherein the partial access restriction further permits access to the first message by the first account if a visible flag is set for the first account.

12. The program product of claim 8, the processor further calculating a response score as a function of a resolution time interval, a message priority, and a public safety rating.

13. The program product of claim 8, wherein each message comprises a title, a message identifier, a creation date, and a note identifier for the note.

14. The program product of claim 13, wherein each note comprises a status, a closed date, and a resolution needed date.

15. An apparatus comprising:
a processor;
a non-transitory memory that stores code executable by the processor to perform:
receiving a message;
storing the message;
vectorizing the message into a self-modifying message data structure comprising a binary value and a weight for each word of text of a note for the message, wherein the weight is modified as a function of word order;
determining the message priority from the vectorized message using a first neural network trained with message priorities;
determining the public safety rating from the vectorized message using a second neural network trained with public safety ratings;
modifying the message priority as a function of the public safety rating; and
communicating the message to accounts through at least one of a plurality of communication channels based on message categories and structured message restrictions comprising full access, partial access, and no access restrictions, wherein a structured message restriction is associated with each message category for each account, the partial access restriction permits access to a first message by a first account only if a message priority for the first message exceeds a message priority threshold, and the message categories comprise resident messages, contractor messages, employee messages, office staff messages, department manager messages, public safety messages, council messages, executive messages, and administrator messages, wherein the note is redacted to a limited set of information for accounts with a partial access restriction.

16. The apparatus of claim 15, the processor further:
estimating computing resources required to filter the self-modifying message data structure; and
filtering the self-modifying message data structure using the estimated computing resources, wherein filtering modifies the self-modifying message data structure.

17. The apparatus of claim 15, wherein the limited set of information limit selectable options available to the recipient.

18. The apparatus of claim 15, wherein the partial access restriction further permits access to the first message by the first account if a visible flag is set for the first account.

19. The apparatus of claim 15, the processor further calculating a response score as a function of a resolution time interval, a message priority, and a public safety rating.

20. The apparatus of claim 15, wherein each message comprises a title, a message identifier, a creation date, and a note identifier for the note.
